(19) United States
(12) Patent Application Publication
(10) Pub. No.: US 2010/0022124 A1
(43) Pub. Date: Jan. 28, 2010

(54) COAXIAL CABLE CONNECTOR

(76) Inventor: Kuen-Ming Shie, Shu-Lin City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/179,795

(22) Filed: Jul. 25, 2008

(51) Int. Cl. H01R 9/05

(52) U.S. Cl. 439/584

(57) ABSTRACT

A coaxial cable connector has a nut, a sleeve and a jacket. The nut has a stop ring formed on an inner surface of the nut. The sleeve is mounted in the nut and has a flange formed on the sleeve and abutting the stop ring of the nut. The jacket is mounted securely on the sleeve and has at least one crimp formed on an inner end of the jacket. When a coaxial cable is connected to the connector, the inner end of the jacket is compressed and the at least one crimp presses into the coaxial cable to prevent air entering and damaging the coaxial cable and proving a tight connection to the coaxial cable.

### BACKGROUND OF THE INVENTION

1. Field of the Invention

The present invention relates to a coaxial cable connector, and more particularly to a connector that tightly connects to a coaxial cable and waterproofs the connected coaxial cable.

2. Description of Related Art

With reference to FIG. 6, a coaxial cable (40) is used in electronics for signal transmission, such as cable TV, hi-fi separates and the like and comprises a dielectric insulator (41), a core wire (42), a metallic shield (43) and a plastic casing (44). The core wire (42) is mounted in a center of the dielectric insulator (41). The metallic shield (43) is mounted on an outer surface of the dielectric insulator (41). The plastic casing (44) covers the metallic shield (43), the dielectric insulator (41) and the core wire (42).

The coaxial cable (40) further connects to a connector to easily connect the coaxial cable (40) to an electronic device. With further reference to FIGS. 7 and 8, the connector comprises a nut (51), a sleeve (52) and a jacket (53). The nut (51) has a stop ring (511) formed on an inner surface of the nut (51). The sleeve (52) passes through the nut (51) and has an outer end, an inner end and a flange (521). The inner end of the sleeve (52) corresponds to the dielectric insulator (41). The flange (521) is formed on the outer end of the sleeve (52) and abuts the stop ring (511). The jacket (53) has an outer end and an inner end. The outer end engages the inner end of the sleeve (52).

When the connector is mounted on the coaxial cable (40), only the dielectric insulator (41) and the core wire (42) will be put into the sleeve (52). The metallic shield (43) and the plastic casing (44) are mounted between the sleeve (52) and the jacket (53). With further reference to FIGS. 9 and 10, the inner end of the jacket (53) is compressed to deform and clamp the metallic shield (43) and the plastic casing (44) to prevent the connector from being removed from the coaxial cable (40).

However, the coaxial cable (40) is not tightly clamped by the jacket (53) of the connector. Therefore, the connector may be detached from the coaxial cable (40) accidentally and cannot be reconnected to the coaxial cable (40) because the jacket (53) is deformed during mounting.

In addition, even the jacket (53) being deformed to engage with the plastic casing (44), a gap still exists between the jacket (53) and the plastic casing (44). In humid conditions, water vapor may enter through the gap and condense between the jacket (53) and the plastic casing (44) to damage the metallic shield (43) and may cause a short circuit.

To overcome the shortcomings, the present invention provides a connector that connects tightly to a coaxial cable and waterproofs the connected coaxial cable to mitigate or obviate the aforementioned problems.

### SUMMARY OF THE INVENTION

The main objective of the invention is to provide a connector proving a tight connection to a coaxial cable for waterproofing the connection.

The connector in accordance with the present invention comprises a nut, a sleeve and a jacket. The nut has a stop ring formed on an inner surface of the nut. The sleeve is mounted in the nut and has a flange formed on the sleeve and abutting the stop ring of the nut. The jacket is mounted securely on the sleeve and has at least one crimp formed on an inner end of the jacket. When a coaxial cable is connected to the connector, the inner end of the jacket is compressed and the at least one crimp presses into the coaxial cable to prevent air entering and damaging the coaxial cable and proving a tight connection to the coaxial cable.

Other objectives, advantages and novel features of the invention will become more apparent from the following detailed description when taken in conjunction with the accompanying drawings.

### BRIEF DESCRIPTION OF THE DRAWINGS

FIG. 1 is an exploded view of a coaxial cable connector in accordance with the present invention and a coaxial cable;

FIG. 2 is a perspective view of the coaxial cable connector in FIG. 1 mounted on a coaxial cable;

FIG. 3 is a side view in cross section of FIG. 2;

FIG. 4 is a perspective view of the coaxial cable connector in FIG. 2, shown clamped on the coaxial cable;

FIG. 5 is a side view in cross section of FIG. 4;

FIG. 6 is an exploded view of a conventional coaxial cable connector and a coaxial cable;

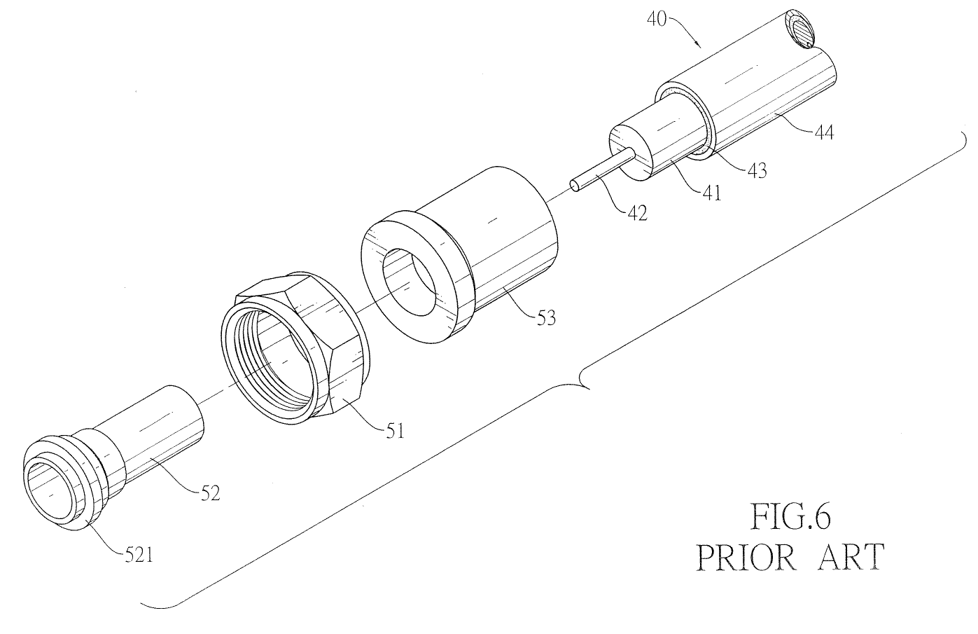

FIG. 7 is a perspective view of the conventional coaxial cable connector in FIG. 6, shown mounted on a coaxial cable;

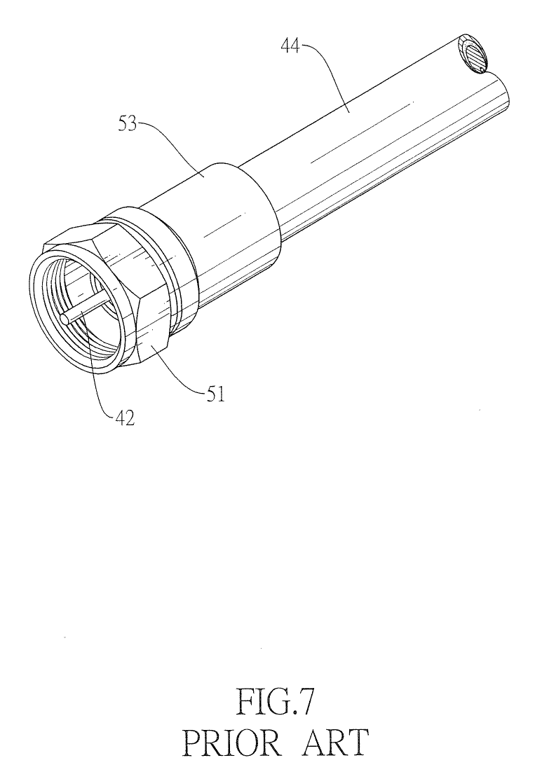

FIG. 8 is a side view in cross section of FIG. 7;

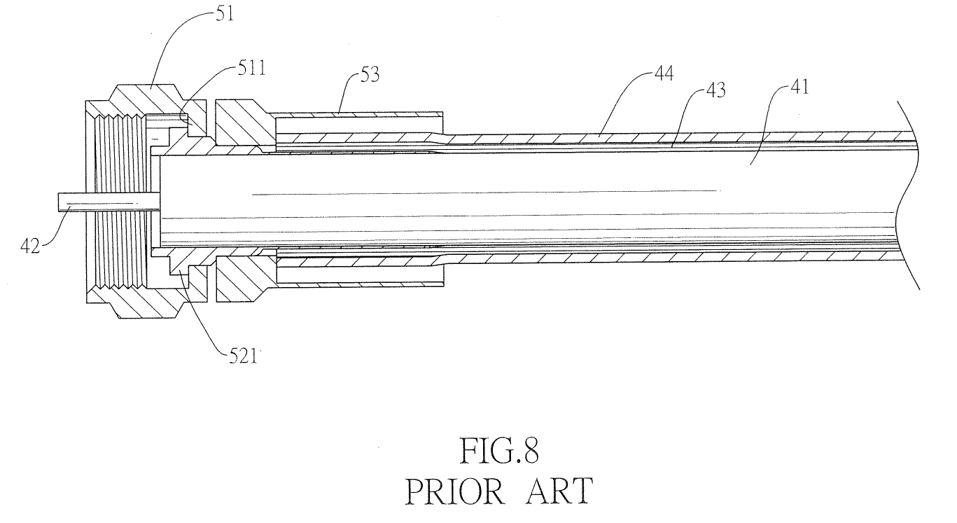

FIG. 9 is a perspective view of the coaxial cable connector in FIG. 7, shown clamped on the coaxial cable; and

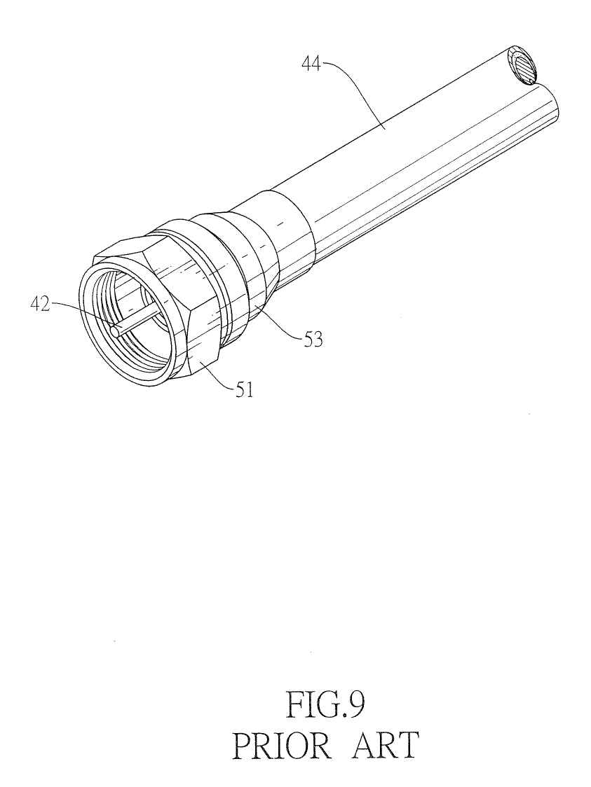

FIG. 10 is a side view in cross section of FIG. 9.

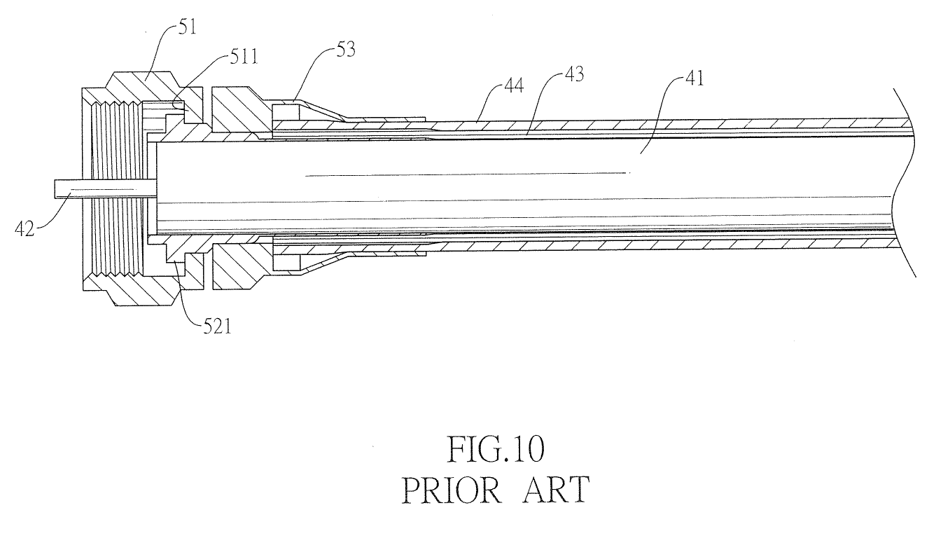

### DETAILED DESCRIPTION OF PREFERRED EMBODIMENTS

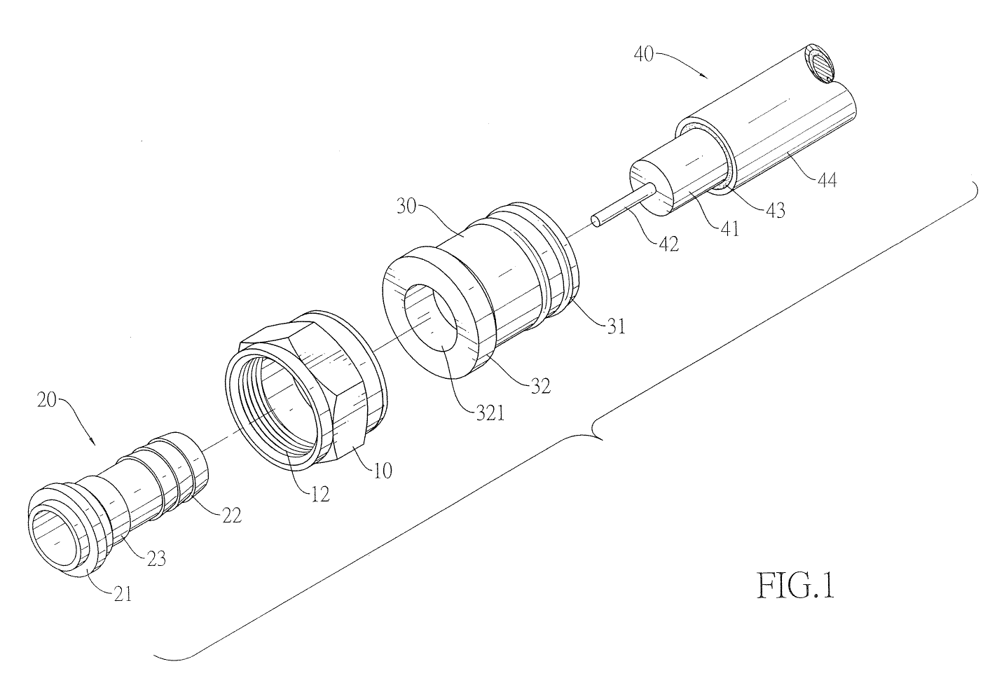

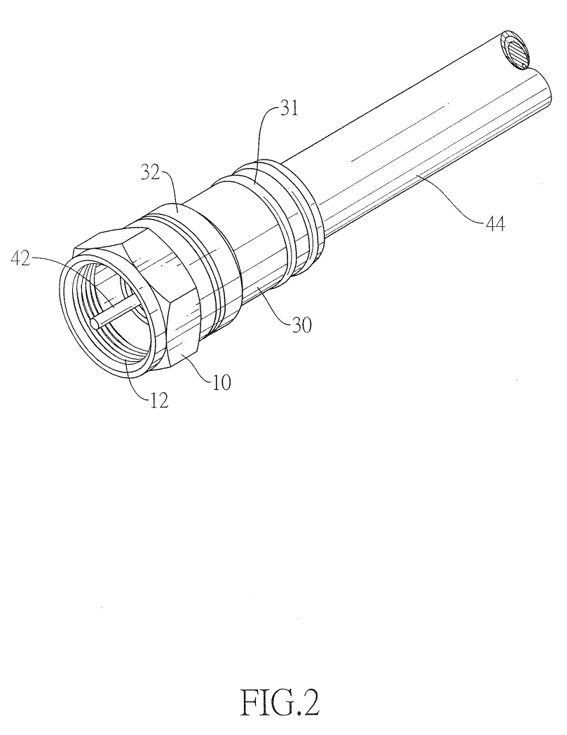

With reference to FIGS. 1 and 2, a coaxial cable connector in accordance with the present invention comprises a nut (10), a sleeve (20) and a jacket (30).

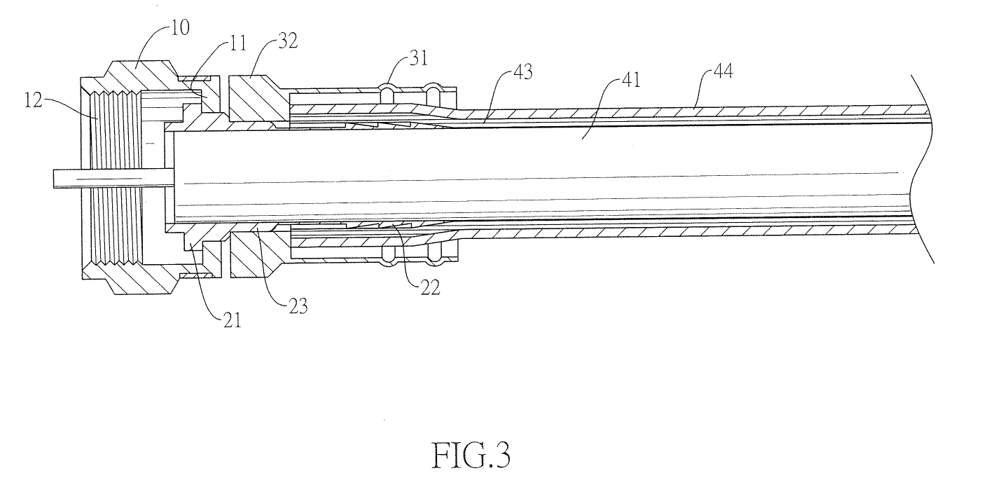

With further reference to FIG. 3, the nut (10) has an inner surface, an outer end, an inner end, a stop ring (11) and an inner thread (12). The stop ring (11) is formed on the inner surface of the nut (10), maybe at the inner end of the nut (10). The inner thread (12) is formed on the inner surface of the nut (10) at the outer end of the nut (10).

The sleeve (20) is smaller than and is mounted in the nut (10). The sleeve (20) has an outer end, an inner end, a flange (21), multiple optional barbs (22) and an optional engaging ring (23). The inner end of the sleeve (20) protrudes through the inner end of the nut (10). The flange (21) is formed on the outer end of the sleeve (20) and abuts the stop ring (11) of the nut (10). The barbs (22) are formed on the inner end of the sleeve (20), may be annular and are taper toward the inner end of the sleeve (20). The engaging ring (23) is formed on and protrudes from the sleeve (20), may be adjacent to the flange (21) and between the spacer (24) and the inner end of the sleeve (20) and may be tapered toward the inner end of the sleeve (20) to aid mounting.

The jacket (30) is mounted securely against the sleeve (20) and has an inner end, an outer end, an inner opening, at least one crimp (31), an outer opening (321) and an optional shoulder (32). The at least one crimp (31) is formed on the jacket (30) adjacent to the inner opening of the jacket (30). In a preferred embodiment of the jacket (30), multiple crimps (31) are formed parallelly on the jacket (30). The inner opening of the jacket (30) is larger than the sleeve (20). The outer opening (321) is formed at the outer end of the jacket (30), corresponds to and is mounted around the engaging ring (23) of the sleeve (20). The shoulder (32) is formed on the jacket (30) at the outer end of the jacket (30).

To attach the connector of the present invention to a coaxial cable (40), the jacket (30) is mounted around the coaxial cable (40) and the sleeve (20) is mounted through the nut (10) and in the coaxial cable (40) between a metallic shield (43) and a dielectric insulator (41) of the coaxial cable (40). Accordingly, the dielectric insulator (41) and a core wire (42) of the coaxial cable (40) protrude into the sleeve (20). Because the barbs (22) on the sleeve (20) taper toward the inner end of the sleeve (20), the barbs (22) allow easy insertion, but prevent removal of the sleeve (20) from the dielectric insulator (41) of the coaxial cable (40).

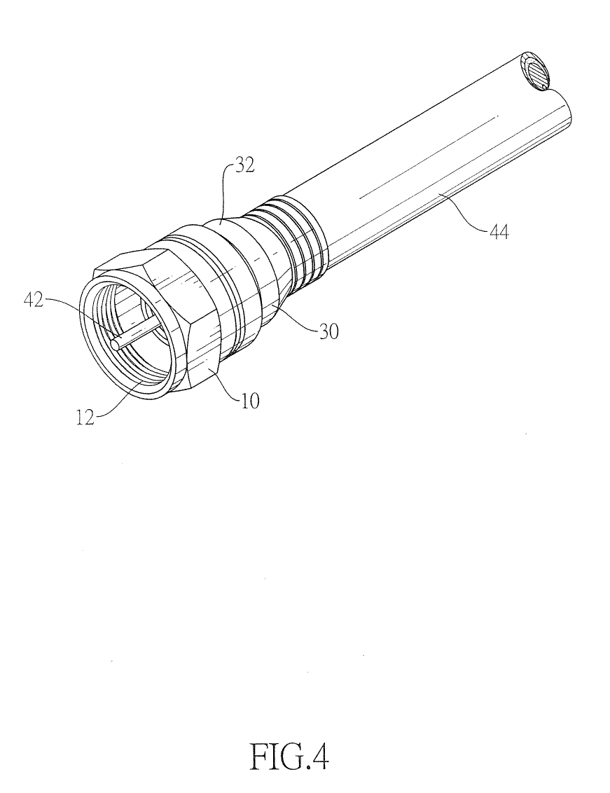

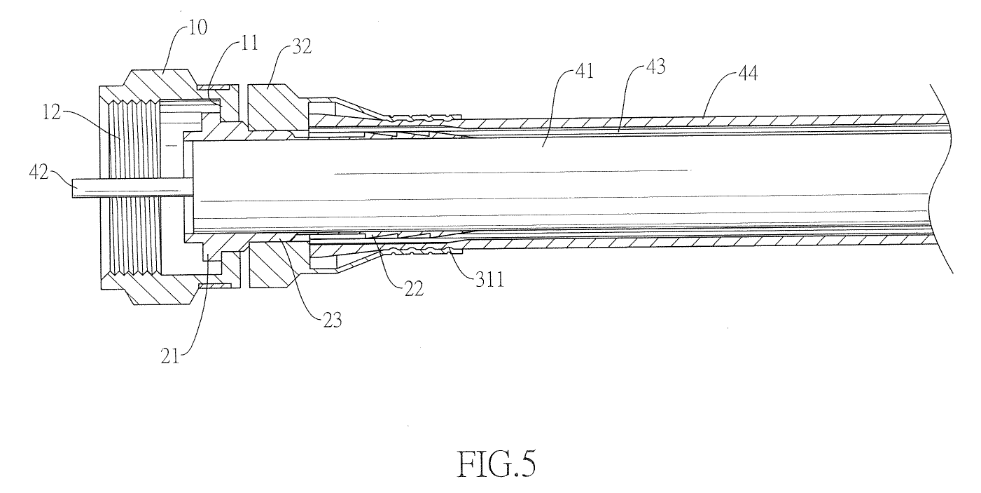

With further reference to FIGS. 4 and 5, the jacket (30) is pressed so the outer opening (321) is forced around the engaging ring (23) to ensure a secure seal. Then the inner end of the jacket (30) is compressed so the inner end securely abuts the coaxial cable (40). Furthermore, because the crimps (31) are also compressed, the crimps (31) are smoothed as flat as the compressed jacket (30) is. Meanwhile, junctions of the jacket (30) and the crimps (31) will be further forced by the crimps (31) to form multiple teeth (311). The teeth (311) protrude into and engage the plastic casing (44) of the coaxial cable (40). Therefore, the connector of the present invention ensures a secure connection between the coaxial cable (40) and the connector and prevents air penetrating the plastic casing (44) of the coaxial cable. More crimps (31) farther improves the secure connection.

Accordingly, the jacket (30) is mounted securely on the sleeve (20) to prevent air passing into and damaging a coaxial cable (40) and the nut (10) is mounted rotatably around the sleeve (20) to enable easy attachment to an electronic device.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A coaxial cable connector comprising:
a nut having an inner surface and a stop ring formed on the inner surface of the nut;
a sleeve being smaller, being mounted in the nut and having
an outer end;
an inner end protruding through the nut; and
a flange being formed on the outer end of the sleeve and abutting the stop ring of the nut; and
a jacket being mounted securely against the sleeve and having
an inner end;
an outer end;
an inner opening being larger than the sleeve; and
at least one crimp being formed on the jacket adjacent to the inner opening.

2. The connector as claimed in claim 1, wherein when the inner end and the crimps of the jacket are compressed, the inner end of the jacket narrows and the crimps are compressed so junctions of the jacket and the crimps are deformed to form multiple teeth protruding inward the jacket.

3. The connector as claimed in claim 1, wherein the sleeve further has multiple barbs being annular, formed on and tapering toward the inner end of the sleeve.

4. The connector as claimed in claim 2, wherein the sleeve further has multiple barbs being annular, formed on and tapering toward the inner end of the sleeve.

5. The connector as claimed in claim 1, wherein multiple crimps are formed parallelly on the jacket.

6. The connector as claimed in claim 2, wherein multiple crimps are formed parallelly on the jacket.

7. The connector as claimed in claim 3, wherein multiple crimps are formed parallelly on the jacket.

8. The connector as claimed in claim 4, wherein multiple crimps are formed parallelly on the jacket.

9. The connector as claimed in claim 1, wherein the nut further has
an outer end;
an inner end; and
an inner thread being formed on the inner surface of the nut at the outer end of the nut, wherein
the stop ring is formed at the inner end of the nut.

10. The connector as claimed in claim 2, wherein the nut further has
an outer end;
an inner end; and
an inner thread being formed on the inner surface of the nut at the outer end of the nut, wherein
the stop ring is formed at the inner end of the nut.

11. The connector as claimed in claim 3, wherein the nut further has
an outer end;
an inner end; and
an inner thread being formed on the inner surface of the nut at the outer end of the nut, wherein
the stop ring is formed at the inner end of the nut.

12. The connector as claimed in claim 4, wherein the nut further has
an outer end;
an inner end; and
an inner thread being formed on the inner surface of the nut at the outer end of the nut, wherein
the stop ring is formed at the inner end of the nut.

13. The connector as claimed in claim 1, wherein:
the sleeve further has an engaging ring being formed on and protruding from the sleeve adjacent to the flange; and
the jacket further has
an outer opening being formed at the outer end of the jacket, corresponding to and being mounted around the engaging ring of the sleeve; and
a shoulder being formed on the jacket at the outer end of the jacket.

14. The connector as claimed in claim 2, wherein:
the sleeve further has an engaging ring being formed on and protruding from the sleeve adjacent to the flange; and
the jacket further has
an outer opening being formed at the outer end of the jacket, corresponding to and being mounted around the engaging ring of the sleeve; and
a shoulder being formed on the jacket at the outer end of the jacket.

15. The connector as claimed in claim 3, wherein:
the sleeve further has an engaging ring being formed on and protruding from the sleeve adjacent to the flange; and
the jacket further has
an outer opening being formed at the outer end of the jacket, corresponding to and being mounted around the engaging ring of the sleeve; and
a shoulder being formed on the jacket at the outer end of the jacket.

16. The connector as claimed in claim 4, wherein:
the sleeve further has an engaging ring being formed on and protruding from the sleeve adjacent to the flange; and
the jacket further has
an outer opening being formed at the outer end of the jacket, corresponding to and being mounted around the engaging ring of the sleeve; and
a shoulder being formed on the jacket at the outer end of the jacket.
